(19) United States
(12) Patent Application Publication
(10) Pub. No.: US 2015/0050096 A1
(43) Pub. Date: Feb. 19, 2015

(54) MACHINE TOOL HAVING PROTECTIVE COVER

(71) Applicant: FANUC Corporation, Yamanashi (JP)

(72) Inventor: Naoki SATO, Yamanashi (JP)

(21) Appl. No.: 14/457,991

(22) Filed: Aug. 12, 2014

(30) Foreign Application Priority Data
Aug. 16, 2013 (JP) 2013-169255

(51) Int. Cl. B23Q 11/08

(52) U.S. Cl. CPC B23Q 11/0891; B23Q 11/0825
USPC 409/134

(57) ABSTRACT

A leaf spring, being a conductive member, fixed to a splash guard body with a fixing bolt, is in contact with a side surface of a door assembled to a predetermined position. The leaf spring is a spring that expands outwardly. The leaf spring is in contact with an uncoated metallic surface of the door.

### BACKGROUND OF THE INVENTION

1. Field of the Invention

The present invention relates to a machine tool having a protective cover.

2. Description of the Related Art

When machining a workpiece, a method of using a splash guard to cover a machining area is generally used to prevent splashing of cutting chips produced during machining and cutting fluid supplied to the workpiece. Furthermore, as a method of preventing electrification of a cover that covers a machine, earthing of the cover may be used. Prior art techniques are disclosed in Japanese Patent Application Laid-Open No. 2007-331050, Japanese Patent Application Laid-Open No. 09-174375, and Japanese Patent Application Laid-Open No. 2000-135629, for example.

Japanese Patent Application Laid-Open No. 2007-331050 discloses, with regard to a cover fixed on the framework of a machine, that a material having conductivity is used for a resin part supporting the cover to prevent electrification of the cover and provide secure grounding. However, no method is mentioned for earthing a moving door.

Japanese Patent Application Laid-Open No. 09-174375 discloses that an expandable and contractible shield member is provided between a fixed cover and a door, and a liquid is supplied into the shield member, whereby the shield member is expanded to securely shield between the fixed cover and the door. However, no method is mentioned for establishing electric connection with the door and the fixed cover constantly in contact with each other.

Japanese Patent Application Laid-Open No. 2000-135629 discloses a method of releasing static electricity accumulated on a fixed resin cover though a metal blush. However, no moving door is present at the corresponding section or no method of earthing the moving door is mentioned.

Wherever the door is positioned in the moving range thereof, if earthing is provided to the door in secure contact with a splash guard body and, when a plurality of doors are present, with the doors in contact with each other, a current flowing on the splash guard body eliminates electrification even in a case where electrification of the door occurs due to some cause. The operator of the machine touching the door is thus protected from an electric shock. Furthermore, noise is prevented from being propagated from outside to the door and thus affecting the machine tool.

### SUMMARY OF THE INVENTION

In view of the above-described problems of the prior art, an object of the present invention is to provide a machine tool having a protective cover that, with respect to a splash guard for covering a machining area to prevent splashing of cutting chips and cutting fluid, has a structure for providing earthing with a door covering an opening part of the splash guard in contact with a splash guard body and, when a plurality of doors are present, with the doors in contact with each other.

A machine tool including a protective cover according to the present invention includes a splash guard body that prevents splashing of cutting fluid and cutting chips produced during machining and one or more doors that cover an opening part provided on the splash guard body. In the machine tool including a protective cover, the one or more doors are electrically conducted with the splash guard body directly or indirectly via one or more conductive members. The one or more doors may include a plurality of doors, the one or more of conductive members may be fixed to one or more of the plurality of doors, the plurality of doors may be in contact with each other via one or more of the conductive members, and the splash guard body and at least one of the doors may be in contact with each other via the one or more of the conductive members, so that the plurality of doors are electrically conducted with the splash guard body. Alternatively, the one or more doors may include a plurality of doors, the one or more conductive members may be fixed to one or more of the plurality of doors, the plurality of doors may be in contact with each other via one or more of the conductive members, the one or more of the conductive members may be fixed to the splash guard body, and at least one of the doors is in contact with the splash guard body via the conductive member provided on the splash guard body, and the plurality of doors are electrically conducted with the splash guard body.

A machine tool having a protective cover according to the present invention includes a splash guard body that prevents splashing of cutting liquids and cutting chips produced during machining and a door that covers an opening part provided on the splash guard body. A conductive member is fixed to one of the splash guard body and the door and is in contact with the other of the splash guard body and the door, and the door is electrically conducted with the splash guard body.

A machine tool having a protective cover according to the present invention includes a splash guard body that prevents splashing of cutting liquids and cutting chips produced during machining and a plurality of doors that cover an opening part provided on the splash guard body. A plurality of conductive members, in contact with the plurality of doors respectively, are fixed to the splash guard body, or the plurality of conductive members are fixed to the plurality of doors respectively, and the plurality of doors are in contact with the splash guard body via the conductive members, and the plurality of doors are electrically conducted with the splash guard body.

A machine tool including a protective cover according to the present invention includes a splash guard body that prevents splashing of cutting fluid and cutting chips produced during machining and a plurality of doors that cover an opening part provided on the splash guard body. A plurality of conductive members, in contact with the plurality of doors respectively, are fixed to the splash guard body, or the plurality of conductive members are fixed to the plurality of doors respectively, and the plurality of doors are in contact with the splash guard body via the plurality of conductive members, and the plurality of doors are electrically conducted with the splash guard body.

A machine tool including a protective cover according to the present invention includes a splash guard body that prevents splashing of cutting fluid and cutting chips produced during machining and a plurality of doors that cover an opening part provided on the splash guard body. The conductive members are fixed to the plurality of doors, the plurality of doors are in contact with each other via the conductive members, the conductive members are fixed to the splash guard body, and at least one of the plurality of doors is in contact with the splash guard body via the conductive member provided on the splash guard body, and the plurality of doors are electrically conducted with the splash guard body.

The conductive member may consists of an elastic member or an elastic member and a block.

With the configuration described above, the present invention can provide a machine tool having a protective cover that, with respect to a splash guard for covering a machining area to prevent splashing of cutting chips and cutting fluid, has a structure for providing earthing with a door covering an opening part of the splash guard in contact with a splash guard body and, when a plurality of doors are present, with the doors in contact with each other.

### BRIEF DESCRIPTION OF THE DRAWINGS

These and other objects and features of the present invention will become apparent from the following description of exemplary embodiments with reference to the accompanying drawings in which:

FIG. 1 is a schematic diagram illustrating an exterior of a splash guard;

FIG. 2 is a front view of the splash guard in a case where a single door is present;

FIG. 3 is a front view of the splash guard in a case where a plurality of doors are present;

FIG. 4 is a top sectional view of the door explaining a door support structure in the case where a single door is present;

FIG. 5 is a top sectional view of the doors explaining a door support structure in the case where a plurality of doors are present;

FIG. 6 is a sectional view of a splash guard body and the door in the case where a single door is present;

FIG. 7 is a sectional view of the splash guard body and the doors in the case where a plurality of doors are present;

FIG. 8 is a diagram explaining a first embodiment of the present invention;

FIG. 9 is a diagram explaining a second embodiment of the present invention;

FIG. 10 is a diagram explaining a third embodiment of the present invention;

FIG. 11 is a diagram explaining a fourth embodiment of the present invention;

FIG. 12 is a diagram explaining a fifth embodiment of the present invention;

FIG. 13 is a diagram explaining an application example of the fifth embodiment of the present invention;

FIG. 14 is a diagram explaining a sixth embodiment and a seventh embodiment of the present invention; and

FIG. 15 is a diagram explaining an application example of the sixth embodiment of the present invention.

### DETAILED DESCRIPTION OF THE PREFERRED EMBODIMENTS

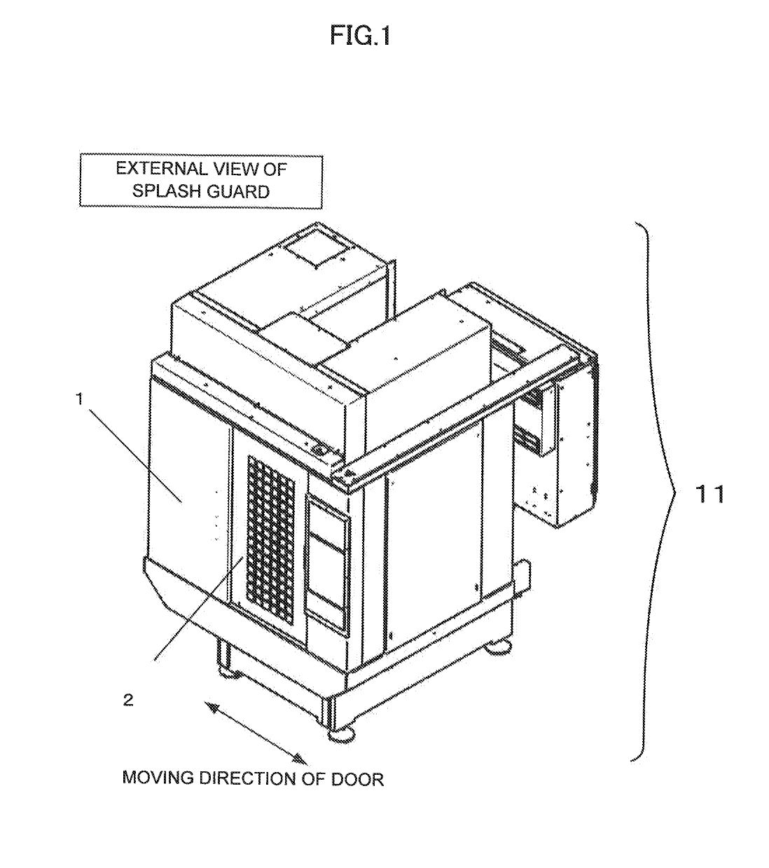

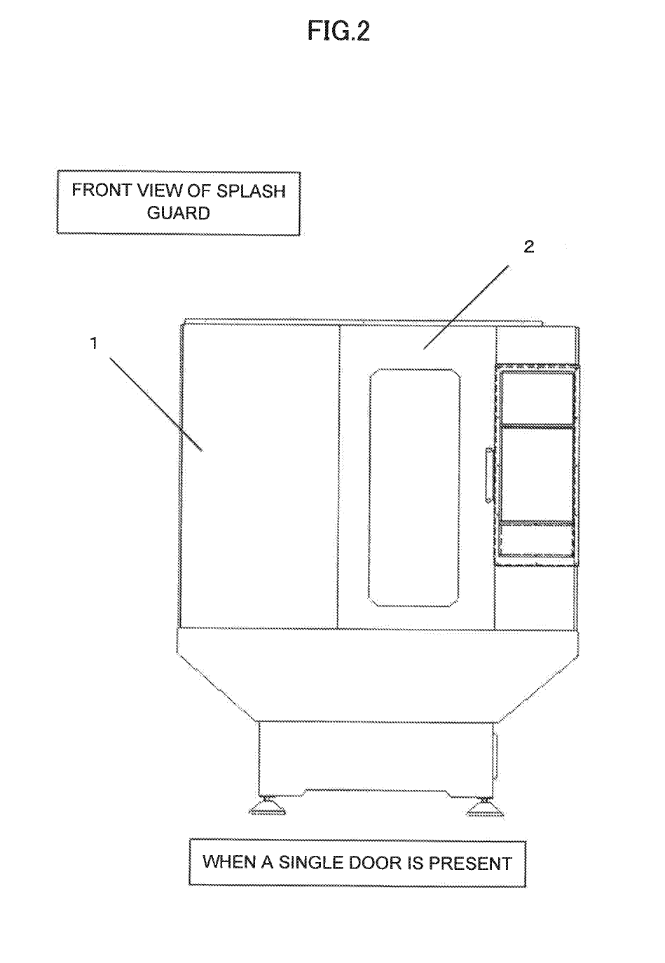

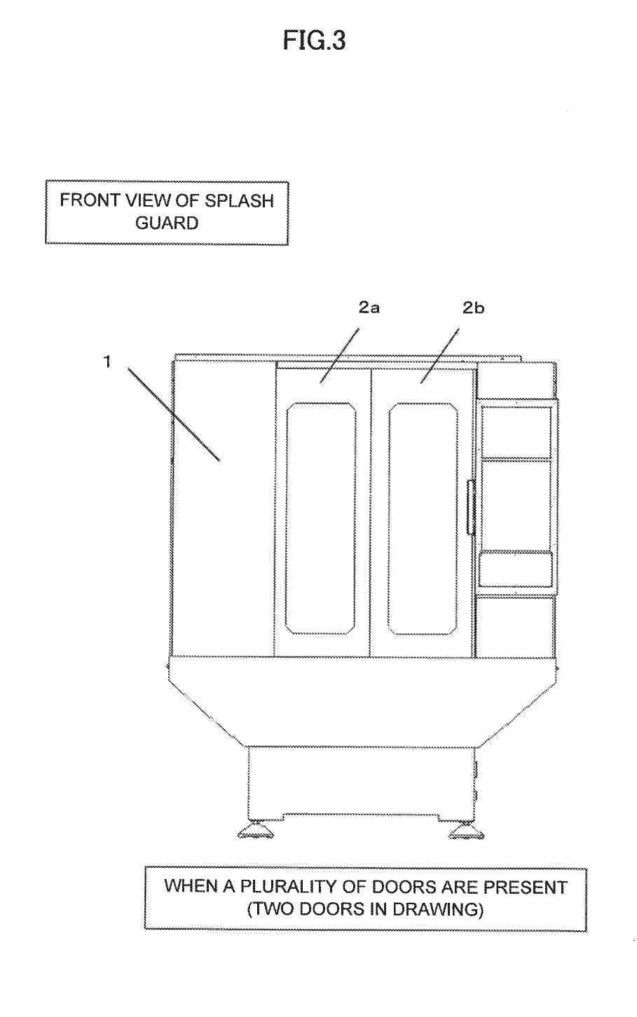

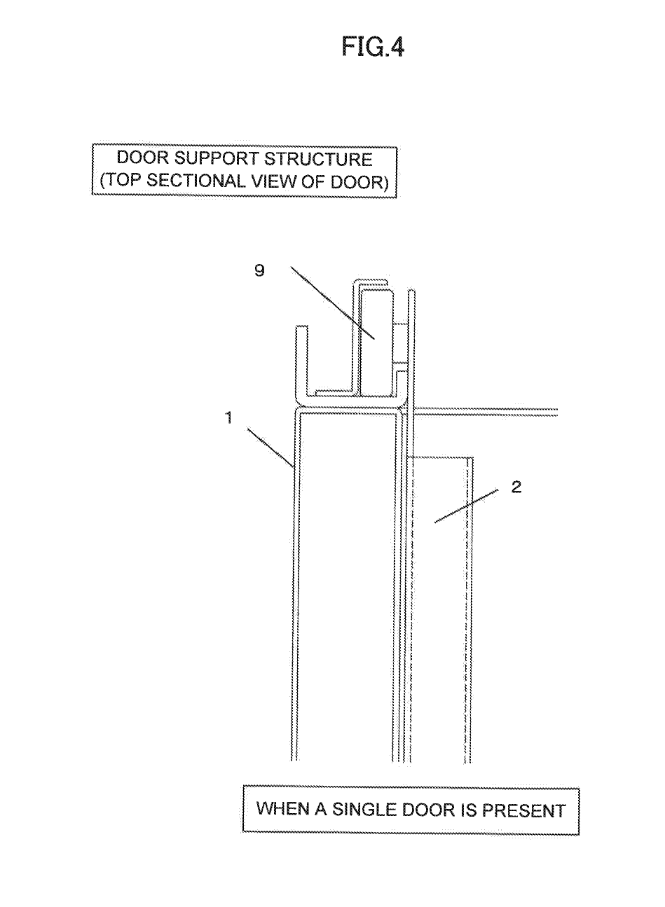

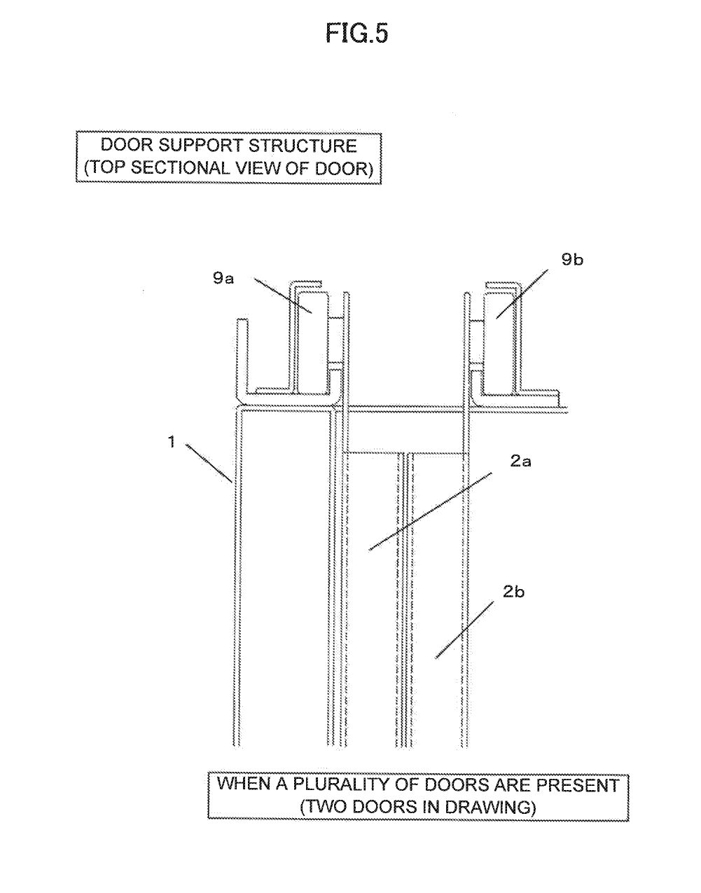

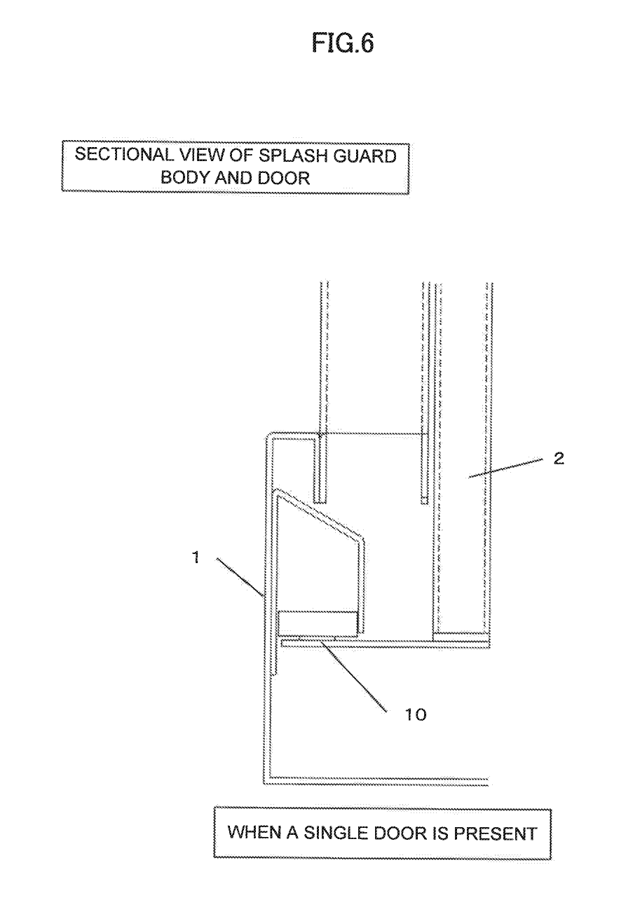

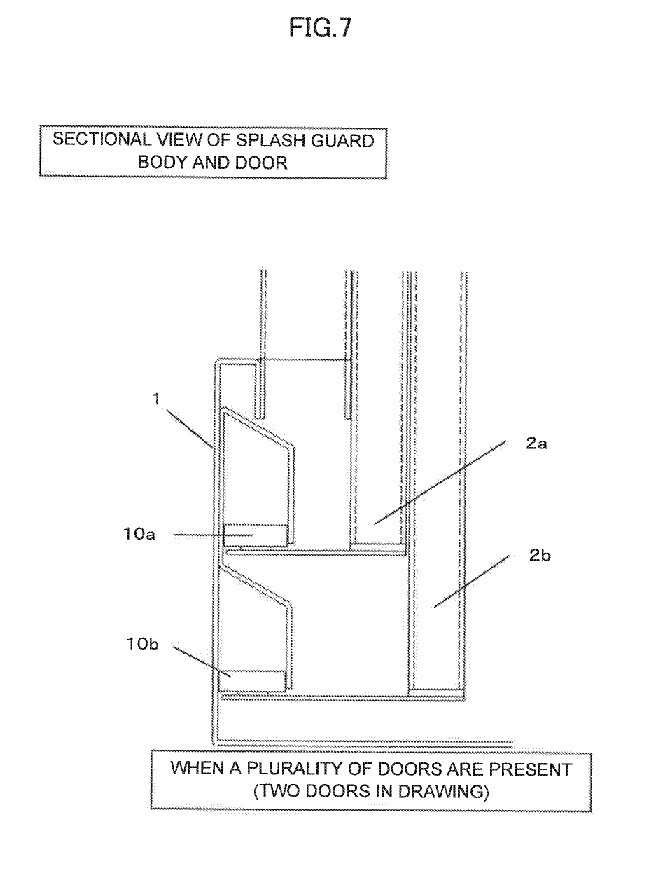

A splash guard of a machine tool will be described. FIG. 1 is a schematic diagram illustrating an exterior of a splash guard. FIG. 2 is a front view of the splash guard in a case where a single door is present. FIG. 3 is a front view of the splash guard in a case where a plurality of doors are present. FIG. 4 is a top sectional view of the door explaining a door support structure in the case where the single door is present. FIG. 5 is a top sectional view of the doors explaining a door support structure in the case where the plurality of doors are present. FIG. 6 is a sectional view of a splash guard body and the door in the case where a single door is present. FIG. 7 is a sectional view of the splash guard body and the doors in the case where a plurality of doors are present. It should be noted that FIGS. 6 and 7 illustrate conventional structures in which earthing is not provided.

As illustrated in FIGS. 2 and 3, the splash guard is structured with a splash guard body 1 combined with a door 2, or doors 2a, 2b . . . when a plurality of doors are present. An upper roller 9, or upper rollers 9a, 9b . . . when a plurality of upper rollers are present, 9a, 9b . . . , supports the door 2 (when a plurality of doors are present, in an upper part. A lower roller 10 or lower rollers when a plurality of lower rollers are present, 10a, 10b . . . , suppresses a backlash of the door or the doors when a plurality of doors are present, 2a, 2b . . . , in a lower part. The splash guard body 1 is earthed to a (whole) machine tool 11. The door 2 (when a plurality of doors are present, 2a, 2b . . . ) opens and closes by moving in parallel with the splash guard body 1.

In the machine tool, a conductive part such as a leaf spring, a coil spring, a coil spring and a block pressed by the coil spring, and a steel wool is used between the door 2 (2a, 2b . . . ) and the splash guard body 1 or between each of the doors so as to contact a conductive portion of the door 2 (2a, 2b . . . ) or the splash guard body 1, whereby earthing is provided.

The above-described conductive parts and the portions contacting therewith may be provided either on the door 2 (2a, 2b . . . ) or the splash guard body 1. Furthermore, the forms and the materials of the contacting portions are not limited and may include an uncoated metal surface, a mechanically-processed surface, and a surface of a conductive part, as long as earthing can be provided. Even when a plurality of doors are present, earthing can be provided in the same manner.

The splash guard body 1 is earthed to the machine tool 11, whereby the door 2 (2a, 2b . . . ) is earthed to the splash guard body 1. With the configuration described above, even in a case where electrification of the door 2 (2a, 2b . . . ) occurs due to some cause, a current flowing on the splash guard body 1 eliminates the electrification. The operator of the machine touching the door 2 (2a, 2b . . . ) is thus protected from an electric shock. Furthermore, noise is prevented from being propagated from outside to the door 2 (2a, 2b . . . ) and thus affecting the machine tool.

Firstly, an embodiment will be described in which a single door 2 is installed on a splash guard body 1.

### First Embodiment

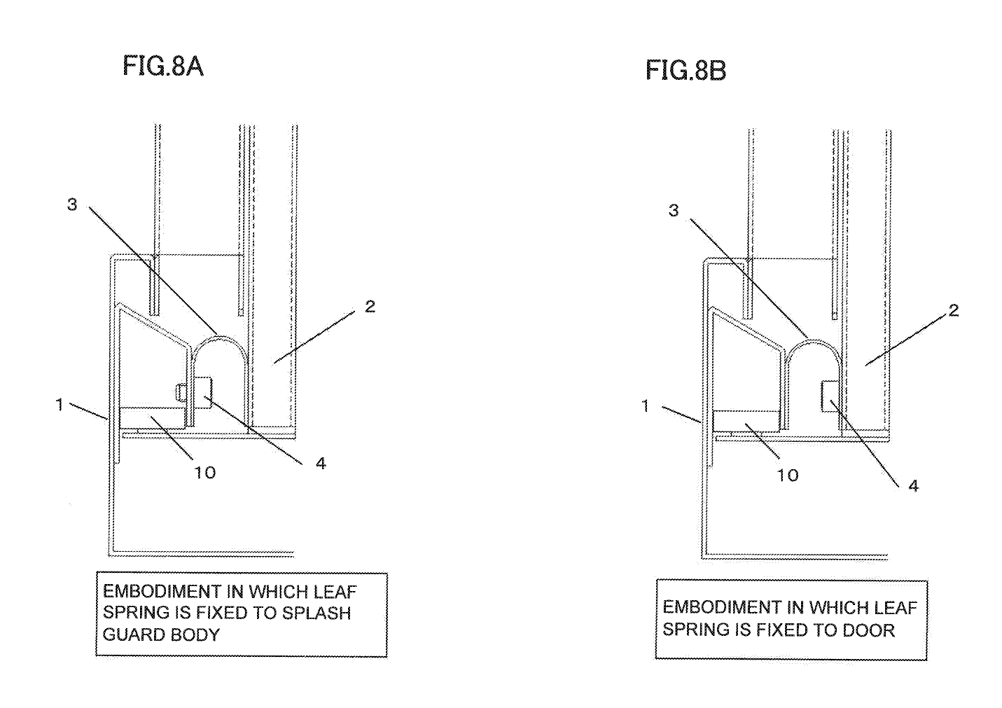

FIG. 8 is a diagram explaining a first embodiment of the present invention.

In the first embodiment, a leaf spring 3 is used as a conductive member. As illustrated in FIG. 8A, the leaf spring 3 as a conductive member is fixed to a splash guard body 1 with a fixing bolt 4. Next, a door 2 is assembled to a predetermined position, so that the leaf spring 3 comes in contact with a side surface of the door 2. The leaf spring 3 is a spring that expands outwardly. The section of the door 2 with which the leaf spring 3 comes in contact is an uncoated metallic surface. With the process described above, the door 2 is earthed to the splash guard body 1. As illustrated in FIG. 8B, even in a case where the spring 3 is fixed to the door 2 with the fixing bolt 4, the section of the splash guard body 1, with which the leaf spring 3 is in contact, is an uncoated metallic surface. It should be noted that the form and the material of the section, with which the leaf spring 3 are in contact, are not limited to particular form or material, as long as earthing can be provided. For example, not only the uncoated metallic surface but also a mechanically-processed surface may be used.

Furthermore, as an application example of the first embodiment, a method is acceptable in which, when the leaf spring 3 is fixed to the splash guard body 1, a conductive part (not illustrated) is fixed to the door 2 in a manner that a surface of the conductive part comes in contact with the leaf spring 3, whereby grounding is provided to the door 2. Naturally, another application example is also acceptable in a form in which the leaf spring 3 is fixed to the door 2, and a conductive part (not illustrated), of which a surface is formed to be the spring 3, is fixed to the splash guard body 1, whereby earthing is provided to the door 2.

With the configuration described above, wherever the door 2 is positioned in the moving range thereof, the door 2 is in secure contact with the splash guard body 1, whereby the door 2 can be earthed. In addition, the leaf spring 3 is replaceable so as to be replaced when worn or damaged.

### Second Embodiment

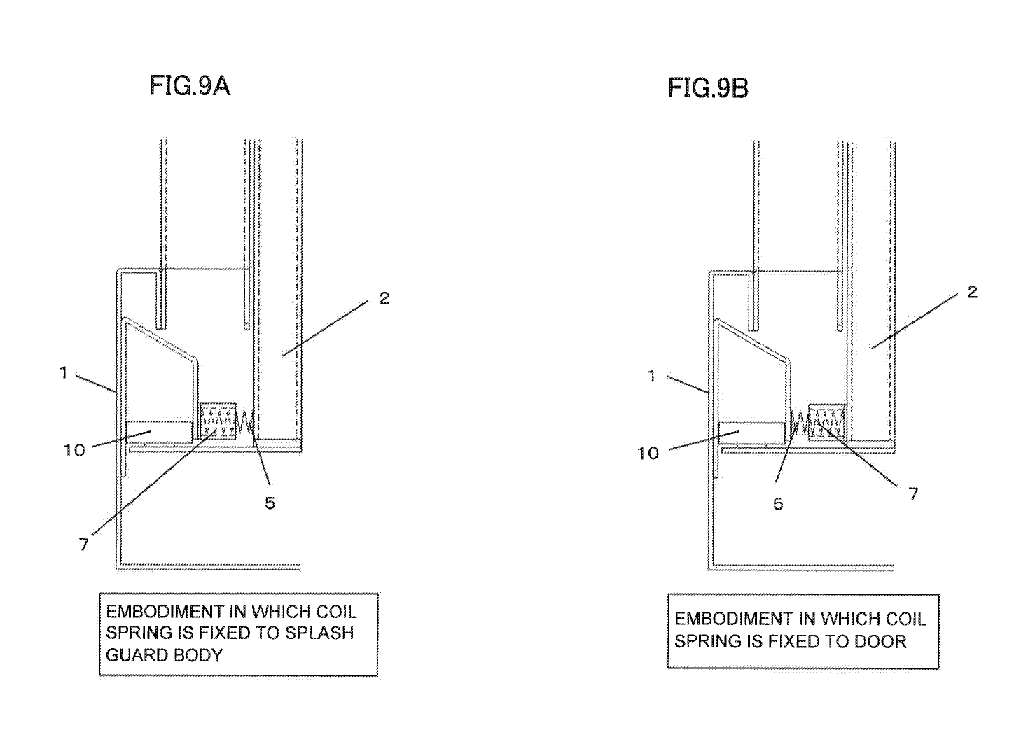

FIG. 9 is a diagram explaining a second embodiment of the present invention.

With respect to the methods described above, in the second embodiment, a coil spring 5 is used as a conductive member instead of the leaf spring 3 in the first embodiment. FIG. 9A illustrates an embodiment in which the coil spring 5 is fixed to the splash guard body 1. FIG. 9B illustrates an embodiment in which the coil spring 5 is fixed to the door 2.

A coil spring support member 7 supports the coil spring 5 as illustrated in FIG. 9A in the direction in which the coil spring 5 is pressed against a side surface of the splash guard body 1, or supports the coil spring 5 as illustrated in FIG. 9B in the direction in which the coil spring 5 is pressed against a side surface of the door 2. Use of the coil spring support member 7 prevents the coil spring 5 from being bent and enables stable contact of the coil spring 5 with the mating part. In addition, the coil spring 5 is replaceable so as to be replaced when worn or damaged.

### Third Embodiment

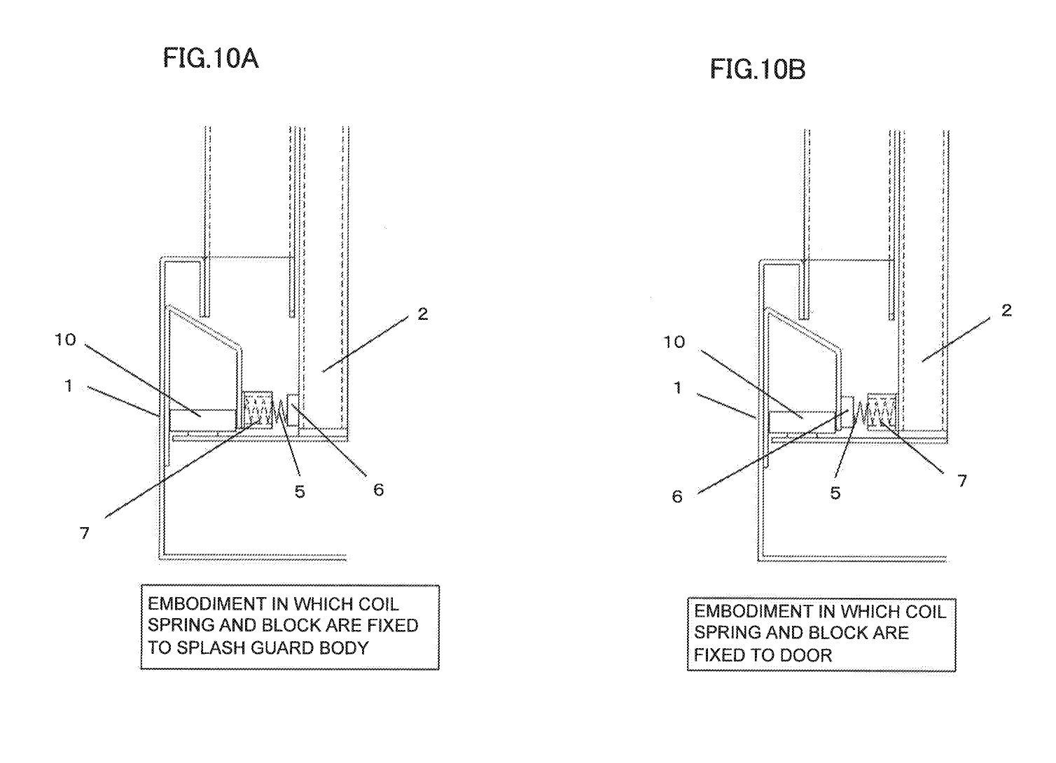

FIG. 10 is a diagram explaining a third embodiment of the present invention. In the third embodiment, the coil spring 5 and a block 6 are used in combination instead of the leaf spring 3 in the first embodiment. FIG. 10A illustrates an embodiment in which the coil spring 5 and the block 6 are fixed to the splash guard body 1. FIG. 10B illustrates an embodiment in which the coil spring 5 and the block 6 are fixed to the door 2.

The coil spring support member 7 supports the coil spring 5 as illustrated in FIG. 9A in the direction in which the coil spring 5 is pressed against a side surface of the splash guard body 1, or supports the coil spring 5 as illustrated in FIG. 9B in the direction in which the coil spring 5 is pressed against a side surface of the door 2. Use of the coil spring support member 7 prevents the coil spring 5 from being bent and enables stable contact of the coil spring 5 or the block 6 with the mating part. In addition, the coil spring 5 and the block 6 are replaceable so as to be replaced when worn or damaged.

### Fourth Embodiment

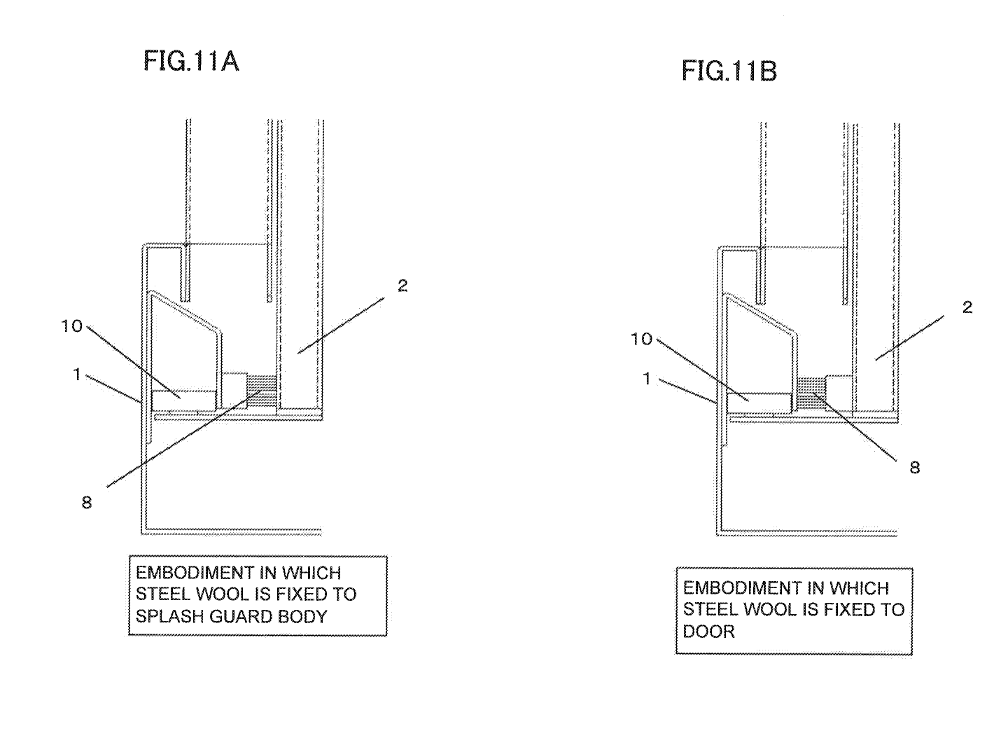

FIG. 11 is a diagram explaining a fourth embodiment of the present invention. In the fourth embodiment, a steel wool 8 is used instead of the leaf spring 3 in the first embodiment. FIG. 11A illustrates a form in which the steel wool 8 is fixed to the splash guard body 1. FIG. 11B illustrates a form in which the steel wool 8 is fixed to the door 2. In addition, the steel wool 8 is replaceable so as to be replaced when worn or damaged.

Next, embodiments in which a plurality of doors are present will be described. Described in fifth and sixth embodiments are examples of the configuration in which two doors are assembled to the splash guard body 1 with the leaf springs 3 used.

### Fifth Embodiment

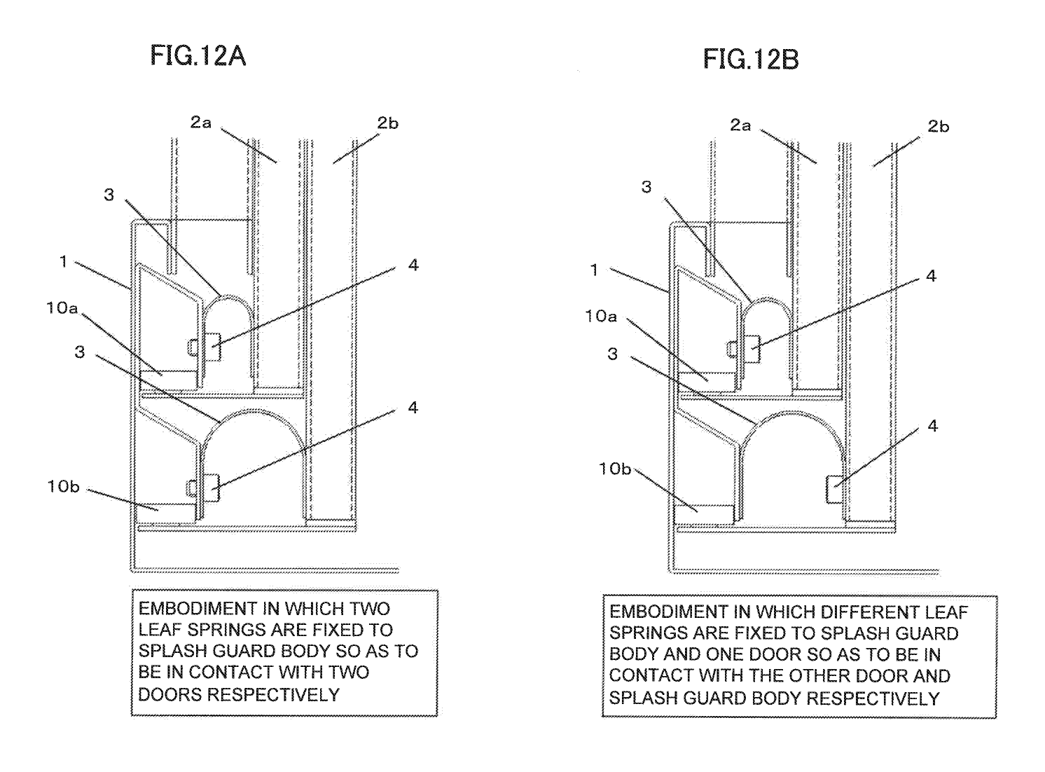

FIG. 12 is a diagram explaining a fifth embodiment of the present invention.

In FIG. 12A, two leaf springs 3 are fixed to the splash guard body 1. FIG. 12A illustrates an embodiment in which each of the two leaf springs 3 is in contact with the door 2a or the door 2b. FIG. 12B illustrates an embodiment in which a first leaf spring 3 is fixed to the splash guard body 1 with the fixing bolt 4 and a second leaf spring 3 is fixed to the door 2b with the fixing bolt 4. The first and the second leaf springs 3 are in contact with the door 2a and the splash guard body 1, respectively. It should be noted that FIG. 12A illustrates a form in which one leaf spring 3 is fixed to each of the door 2a and the door 2b with the fixing bolt 4 and each of the leaf springs 3 is in contact with the splash guard body 1. Similarly to the embodiment described above, the sections with which the leaf springs 3 come in contact are uncoated metallic surfaces.

Furthermore, a method is acceptable in which, when the leaf springs 3 are fixed to the splash guard body 1, conductive parts (not illustrated) are fixed to the doors 2a and 2b in a manner that the conductive parts are in contact with the leaf springs 3, whereby earthing is provided to the doors 2a and 2b. Naturally, a form is also acceptable in which the leaf springs 3 are fixed to the doors 2 and conductive parts (not illustrated) are fixed to the splash guard body 1, whereby earthing is provided to the door 2, similarly to the application example described above.

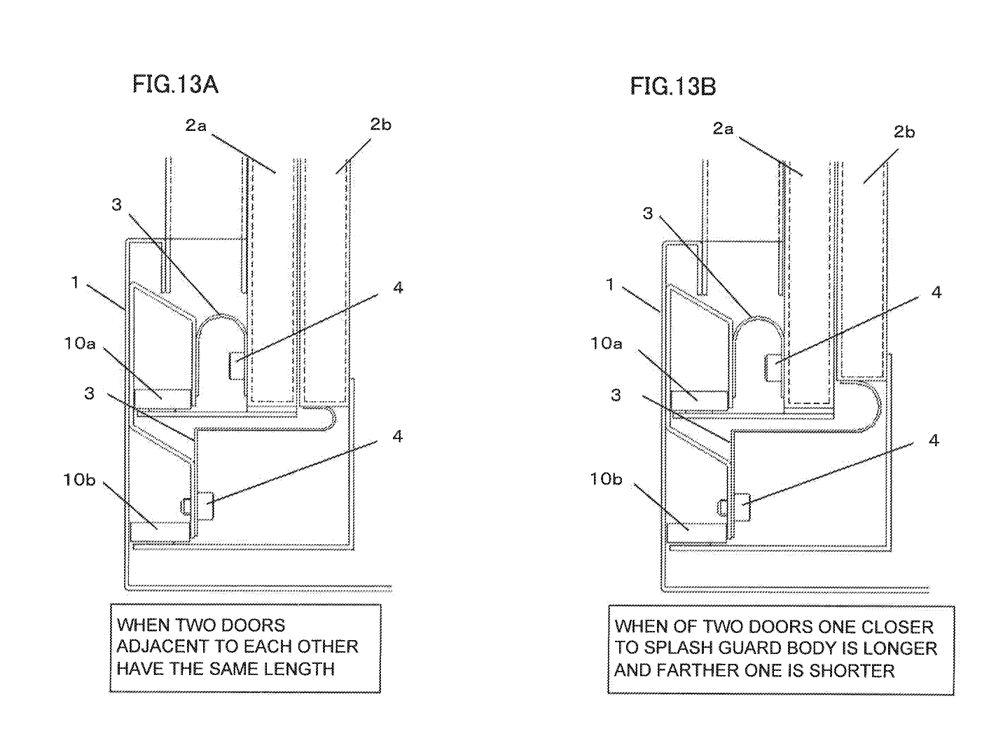

FIG. 13 is a diagram explaining an application example of the fifth embodiment of the present invention. FIG. 13A illustrates an embodiment in which the two doors 2a, 2b adjacent to each other have the same length in the vertical direction. FIG. 13B illustrates an embodiment in which one of the two doors that is closer to the splash guard body 1 is longer than the farther one.

### Sixth and Seventh Embodiment

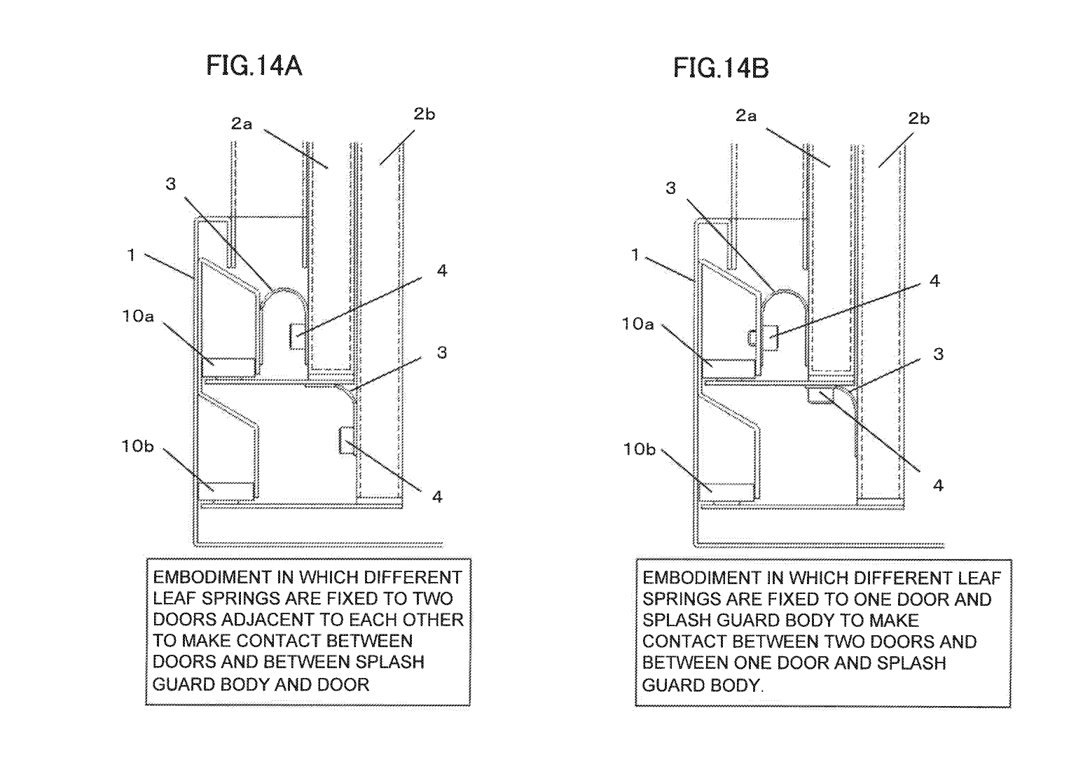

FIG. 14 is a diagram explaining a sixth embodiment (FIG. 14A) and a seventh embodiment (FIG. 14B) of the present invention. As illustrated in FIG. 14A, in the sixth embodiment, a different leaf spring 3 is fixed to each of the door 2a and the door 2b. The door 2a and the door 2b are in contact with each other with one leaf spring 3 and the door 2a is in contact with the splash guard body 1 with the other leaf spring 3. It should be noted that a form is acceptable in which the sections to which the leaf springs 3 are fixed are changed between the door 2a and the door 2b.

Furthermore, a method is acceptable in which a conductive part (not illustrated) is fixed to the splash guard body 1 in a manner that the conductive part is in contact with the leaf spring 3, whereby earthing is provided to the door 2a and a conductive part (not illustrated) is fixed to the door 2a in a manner that the conductive part is in contact with the leaf spring 3, whereby earthing is provided to the door 2b. It should be noted that a form is acceptable in which the sections to which the leaf springs 3 and conductive parts (not illustrated) are fixed are changed between the door 2a and the door 2b.

As illustrated in FIG. 14B, in the seventh embodiment, a different leaf spring 3 is fixed to each of the door 2a and the splash guard body 1. The door 2a and the door 2b are in contact with each other with one leaf spring 3 and the door 2a is in contact with the splash guard body 1 with the other leaf spring 3. It should be noted that a form is acceptable in which the sections to which the leaf springs 3 are fixed are changed between the door 2a and the door 2b. It should be noted that a form is acceptable in which the sections, to which the leaf springs 3 are fixed, are changed between the door 2a and the door 2b.

Furthermore, a method is acceptable in which a conductive part (not illustrated) is fixed to the door 2a in a manner that the conductive part is in contact with the leaf spring 3, whereby earthing is provided to the door 2a and a conductive part (not illustrated) is fixed to the door 2b in a manner that the conductive part is in contact with the leaf spring 3, whereby earthing is provided to the door 2b. It should be noted that a form is acceptable in which the sections to which the leaf springs 3 and conductive parts (not illustrated) are fixed are changed between the door 2a and the door 2b.

Described in the sixth and the seventh embodiments are cases where the vertical dimension of the door 2a which is closer to the splash guard body 1 is larger than that of the door 2b. However, also acceptable as application examples are a case where the door 2a and the door 2b have the same length and a case where the vertical dimension of the door 2b is smaller than that of the door 2a.

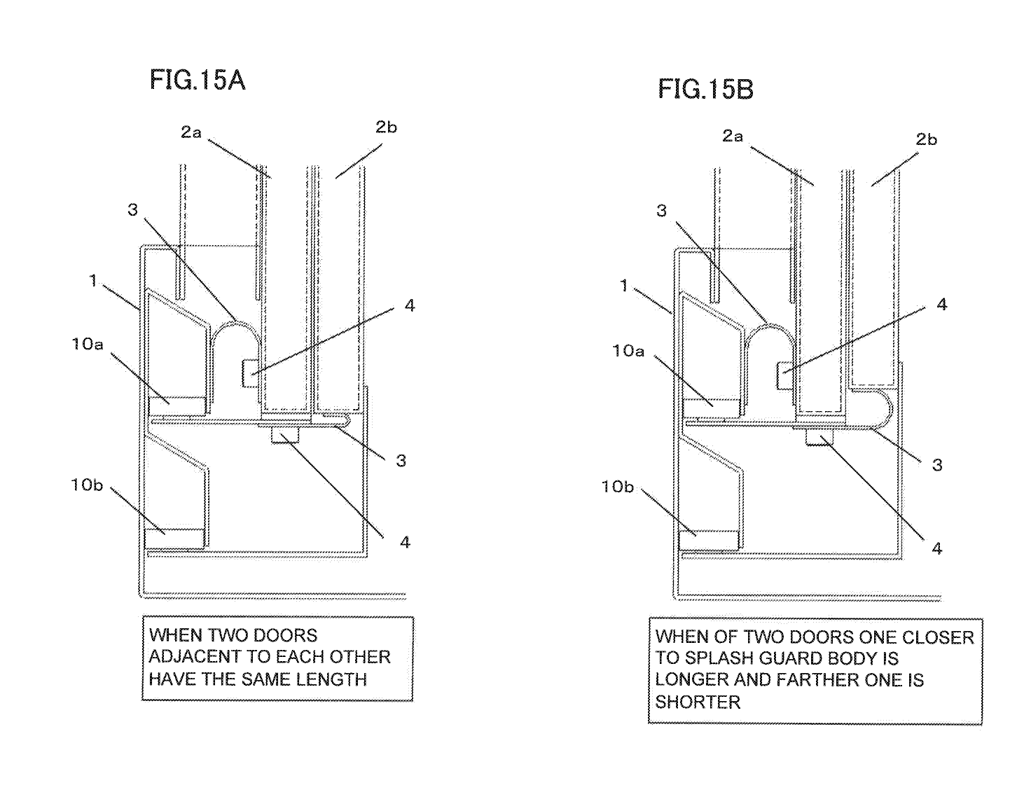

FIG. 15 is a diagram explaining an application example of the sixth embodiment of the present invention. FIG. 15A illustrates an embodiment in which the two doors 2a and 2b adjacent to each other have the same length. In this embodiment, one leaf spring 3 is fixed to each of a side part and a bottom part of the door 2a with the fixing bolt 4. The leaf spring 3 fixed to the side part of the door 2a is in contact with the splash guard body 1, and the leaf spring 3 fixed to the bottom part of the door 2a is in contact with a bottom part of the door 2b. FIG. 15B illustrates a case where, of the two doors 2a and 2b, the one closer to the splash guard body 1 is longer, and the farther one is shorter.

The conductive parts described above and the surfaces that is in contact with the conductive parts may be provided either the door 2 (when a plurality of doors are present, 2a, 2b . . . ) or the splash guard body 1. Furthermore, the forms and the materials of the contacting surfaces are not limited and may include an uncoated metal surface, a mechanically-processed surface, and a surface of a conductive part, as long as earthing can be provided.

With the methods described above, the door 2 (when a plurality of doors are present, 2a, 2b . . . ) is earthed to the splash guard body 1, so that even in a case where electrification of the door 2 (2a, 2b . . . ) occurs due to some cause, a current flowing on the splash guard body 1 eliminates the electrification. The operator of the machine touching the door 2 (when a plurality of doors are present, 2a, 2b . . . ) is thus protected from an electric shock. Furthermore, noise is prevented from being propagated from outside to the door 2 (when a plurality of doors are present, 2a, 2b . . . ) and thus affecting the machine tool.

In the description of claims in the present specification, as conductive members, the designation 3 corresponds to a leaf spring, 5 corresponds to a coil spring, 6 corresponds to a block, and 8 corresponds to a steel wool. Furthermore, among the conductive members, to an elastic member, a leaf spring 3, a coil spring 5, and a steel wool 8 correspond. To a combination of an elastic member and a block, a combination of a coil spring 5 and a block 6 corresponds. In addition, 4 corresponds to a bolt fixing a leaf spring, 7 corresponds to a coil spring support member, and 11 corresponds to a (whole) machine tool.

1. A machine tool including a protective cover comprising:
a splash guard body that prevents splashing of cutting fluid and cutting chips produced during machining;
one or more doors that cover an opening part provided on the splash guard body; and
the one or more doors are electrically conducted with the splash guard body directly or indirectly via one or more conductive members.

2. A machine tool including a protective cover comprising:
a splash guard body that prevents splashing of cutting fluid and cutting chips produced during machining; and
a door that covers an opening part provided on the splash guard body; and
a conductive member is fixed to one of the splash guard body and the door and is in contact with the other of the splash guard body and the door, and the door is electrically conducted with the splash guard body.

3. A machine tool including a protective cover comprising:
a splash guard body that prevents splashing of cutting fluid and cutting chips produced during machining; and
a plurality of doors that cover an opening part provided on the splash guard body; and
a plurality of conductive members, in contact with the plurality of doors respectively, are fixed to the splash guard body, or the plurality of conductive members are fixed to the plurality of doors respectively and the plurality of doors are in contact with the splash guard body via the plurality of conductive members, and the plurality of doors are electrically conducted with the splash guard body.

4. The machine tool including a protective cover according to claim 1, wherein
the one or more doors comprises a plurality of doors,
the one or more conductive members are fixed to one or more of the plurality of doors,
the plurality of doors are in contact with each other via one or more of the conductive members, and
the splash guard body and at least one of the doors are in contact with each other via the one or more of the conductive members, and the plurality of doors are electrically conducted with the splash guard body.

5. The machine tool including a protective cover according to claim 1, wherein
the one or more doors comprises a plurality of doors,
the one or more conductive members are fixed to one or more of the plurality of doors,
the plurality of doors are in contact with each other via one or more of the conductive members,
the one or more of the conductive members are fixed to the splash guard body, and
at least one of the doors is in contact with the splash guard body via the conductive member provided on the splash guard body, and the plurality of doors are electrically conducted with the splash guard body.

6. The machine tool including a protective cover according to claim 1, wherein the conductive member consists of an elastic member or comprising an elastic member and a block.
